(19) United States
(12) Patent Application Publication
(10) Pub. No.: US 2026/0149366 A1
(43) Pub. Date: May 28, 2026

(54) SYSTEM AND METHOD FOR SLOW-LEG CONTROL IN TOTEM POLE POWER FACTOR CORRECTION CONVERTER

(71) Applicant: SEMICONDUCTOR COMPONENTS INDUSTRIES, LLC, Scottsdale, AZ (US)

(72) Inventors: Hyunchul EUM, Chandler, AZ (US); Wookang JIN, Chandler, AZ (US)

(73) Assignee: SEMICONDUCTOR COMPONENTS INDUSTRIES, LLC, Scottsdale, AZ (US)

(21) Appl. No.: 19/311,849

(22) Filed: Aug. 27, 2025

Related U.S. Application Data
(60) Provisional application No. 63/723,989, filed on Nov. 22, 2024.

(51) Int. Cl. H02M 1/42; H02M 7/217

(52) U.S. Cl. CPC H02M 1/4208; H02M 7/217

(57) ABSTRACT

Totem pole power factor correction (PFC) converters. Example embodiments include methods for operating a PFC converter, including: conducting, by an inductor, current between a first AC input node and a fast-leg switch node; generating, by a fast leg, a DC output voltage between a positive output node and a negative output node by selectively conducting current between the fast-leg switch node and each of: the positive output node and the negative output node; selectively conducting, by a slow-leg high-side switch, current between a second AC input node and the positive output node; selectively conducting, by a slow-leg low-side switch, current between the second AC input node and the negative output node; and operating a field effect transistor in at least one of the slow-leg low-side switch or the slow-leg high-side switch in a saturation mode to progressively change a voltage on the second AC input node.

### CROSS-REFERENCE TO RELATED APPLICATIONS

This application claims the benefit of U.S. Provisional Application No. 63/723,989 filed Nov. 22, 2024 and titled “Totem Pole Power Factor Correction, Slow Leg Control.” The provisional application is incorporated by reference herein as if reproduced in full below.

### BACKGROUND

A power factor correction (PFC) converter can be configured to receive an AC line voltage at its input and generate a regulated DC voltage at its output. The PFC circuit may use switches toggled at a pulse width modulation (PWM) frequency for power conversion and may further include circuitry for rectification. The circuitry for rectification can include switches, toggled according to a polarity of an AC line voltage. The PFC converter having switches for power conversion and rectification is referred to as a totem pole PFC converter.

At a zero crossing point of input voltage, the rectification switches, also called slow-leg switches, are each changed between conductive and non-conductive states. However, traditional operation of the slow leg switches can cause transient currents and/or surges input voltage, which can result in common mode noise, and/or EMI (Electromagnetic Interference).

### BRIEF DESCRIPTION OF THE DRAWINGS

For a detailed description of example embodiments, reference will now be made to the accompanying drawings in which:

FIG. 1 shows a schematic diagram of a totem pole PFC system, according to an aspect of the present disclosure;

FIG. 2 shows a graph illustrating operation of the totem pole PFC converter of FIG. 1;

FIG. 3 shows a schematic block diagram of a first slow-leg switch, in accordance with an aspect of the present disclosure;

FIG. 4 shows a graph illustrating operation of a slow-leg bridge in a totem pole PFC, with the first slow-leg switch of FIG. 3;

FIG. 5 shows a schematic block diagram of a second slow-leg switch, in accordance with an aspect of the present disclosure;

FIG. 6 shows a graph illustrating operation of a slow-leg bridge in a totem pole PFC, with the second slow-leg switch of FIG. 5;

FIG. 7 shows a schematic diagram of a current source of the second slow-leg switch of FIG. 5, in accordance with an aspect of the present disclosure;

FIG. 8 shows a chart listing method steps in accordance with at least some embodiments.

### DEFINITIONS

Various terms are used to refer to particular system components. Different companies may refer to a component by different names - this document does not intend to distinguish between components that differ in name but not function. In the following discussion and in the claims, the terms “including” and “comprising” are used in an open-ended fashion, and thus should be interpreted to mean “including, but not limited to....” Also, the term “couple” or “couples” is intended to mean either an indirect or direct connection. Thus, if a first device couples to a second device, that connection may be through a direct connection or through an indirect connection via other devices and connections.

“Controller” shall mean, alone or in combination, individual circuit components, an application specific integrated circuit (ASIC), a microcontroller with controlling software, a reduced-instruction-set computer (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

In relation to electrical devices, the terms “input” and “output” refer to electrical connections to the electrical devices, and shall not be read as verbs requiring action. For example, a controller may have a gate output and one or more sense inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Example embodiments are directed to methods and systems for a power factor correction (PFC) converter with a slow-leg switch driver configured to gradually change a slow-leg voltage on a slow-leg node over a period of time in order to reduce or eliminate the transient currents that can otherwise result from switching the slow-leg switches at a zero crossing point of input voltage. The methods and systems of the present disclosure can, therefore, reduce or eliminate undesirable effects, such as surges in input current, common mode noise, and/or EMI (Electromagnetic Interference).

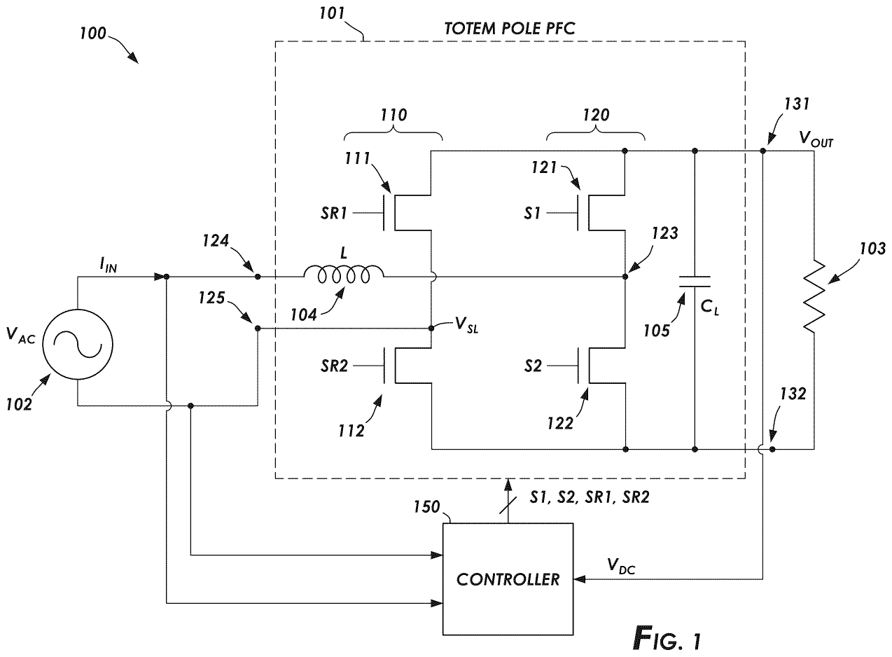

Alternative solutions have been proposed to operate fast-leg switches in a totem pole PFC converter with relatively high-speed switching frequency to gradually change a slow-leg voltage on a slow-leg node over a period of time around a zero crossing of the line voltage V_{AC}. However, such solutions can cause undesired effects. For example, and with reference to FIG. 1, the high-speed operation of the fast-leg switches 121, 122 around a zero crossing of the line voltage V_{AC} can induce inductor current through the inductor 104 and the AC power source 102 to the second AC input node 125, so that the slow-leg voltage V_{SL} on the second AC input node 125 can be transitioned by the fast-leg switches 121, 122. This may be called indirect V_{SL} transition driving, and may require the controller 150 to include additional switching logic to implement. Additionally, such indirect V_{SL} transition driving can cause undesirable distortion of the input current I_{IN} due to induced current in the inductor 104.

FIG. 1 shows a schematic diagram of a PFC system 100 for converting AC power to DC power. The PFC system 100 includes an AC power source 102. For example, the AC power source 102 can be a line voltage (e.g., 120 VAC@60 Hz, 230 VAC @50 Hz, etc.). The AC power source 102 defines an AC line voltage V_{AC} between a first AC input node 124 and a second AC input node 125.

The PFC system 100 further includes a load 103. The load 103 is represented as a resistor. However, the load 103 may include a combination of resistive and/or reactive components. The load 103 may include, for example, a DC-DC converter, such as a converter used in a battery charging system. The PFC system 100 further includes a PFC converter 101 that is configured to transform the AC voltage (VAC) (i.e., line voltage) at its input to a DC voltage (VDC) at its output (e.g., 400V). While the DC voltage can be regulated, the current supplied to the load 103 may vary based on a load condition.

The PFC converter 101 has a totem pole topology that includes a plurality of switches that can be controlled ON/OFF. The PFC system 100 further includes a controller 150 that is configured to generate switching signals to control the ON/OFF state of each of the plurality of switches. The plurality of switches may be configured by the switching signals to form different circuit configurations that change with time to perform the transformation of VAC to VDC.

The transformation may include a boost conversion process. The PFC converter 101 may use a boost conversion process to output a DC level higher than a peak input voltage. For example, the PFC converter 101 may generate a DC output voltage V_{OUT} at approximately 400VDC (e.g., 395VDC) for an input line voltage V_{AC} in a range from 90VAC to 264VAC. To support the boost conversion process, the PFC converter 101 includes an inductor 104 connected between the first AC input node 124 and a fast-leg switch node 123 of the PFC converter 101. Further, the PFC converter 101 may include an output capacitor 105 with a capacitance C_{L}, and connected between a positive output node 131 and a negative output node 132, in parallel with the load 103.

In FIG. 1, the PFC converter 101 is shown as including the inductor 104 and the output capacitor 105. The boundary shown (i.e., dotted line) illustrates a functional group to help understanding and is not intended to be limiting to a possible physical implementation. For example, in a practical implementation of the PFC converter 101, the inductor 104 and/or the output capacitor 105 may be discrete elements.

The PFC converter 101 can be operated by switching signals to perform a boost conversion process. The boost conversion process may include repeatedly: (i) charging the inductor 104 to increase an inductor current therethrough, (ii) discharging the inductor 104 to charge the output capacitor 105 in order to generate a DC output voltage V_{OUT} for the load 103, and (iii) discharging the output capacitor 105 to maintain the DC output voltage V_{OUT} applied to the load 103, while recharging the inductor 104 for the next cycle.

To perform the boost conversion process, the switching signals from the controller 150 may switch one or more of the switches in the PFC converter 101 at a pulse width modulated (PWM) switching frequency. The PWM switching frequency can be higher than a source frequency (i.e., line frequency) of the AC power source 102. Accordingly, these switching signals may be referred to as high-frequency switching signals (i.e., PWM switching signals, boost switching signals).

The PFC converter 101 can be further configured by switching signals from the controller 150 to perform a rectification process. The rectification process may include switching nodes coupled to the AC power source 102. Accordingly, the switching signals for the rectification process can switch at the line frequency, and therefore may be referred to as low-frequency or slow switching signals.

As mentioned, the PFC converter 101 includes a plurality of switches. The plurality of switches in the PFC converter 101 can be implemented using transistors of various technologies, such as metal oxide semiconductor field effect transistors (MOSFET), and various types, such as N-type. In some implementations, one or more of the plurality of switches may require a low reverse recovery and therefore may utilize a wide bandgap (WBG) technology. For example, a WBG switch can be implemented using GaN HEMT or SiC FET technology. These switch examples are not intended to be limiting because the disclosed techniques can be applied to any switch suitable for control by signals (e.g., voltage signals, current signals) transmitted from the controller 150.

The PFC converter 101 includes a slow leg 110 for rectifying AC power from the AC power source 102. The slow leg 110 includes a slow-leg high-side switch 111 configured to selectively conduct current between the second AC input node 125 and the positive output node 131 of the PFC converter 101. The slow-leg high-side switch 111 includes a field effect transistor (FET) that can be controlled ON/OFF by a first synchronous rectification signal SR1, at its gate terminal. The slow leg 110 also includes a slow-leg low-side switch 112 configured to selectively conduct current between the second AC input node 125 and the negative output node 132 of the PFC converter 101. The slow-leg low-side switch 112 includes a FET that can be controlled ON/OFF by a second synchronous rectification signal SR2 at its gate terminal. The synchronous rectification signals SR1, SR2, may also be called low-frequency signals, because they may operate at a relatively low frequency of the AC power from the AC power source 102.

The PFC converter 101 also includes a fast leg 120, which may also be called a fast-leg branch. The fast leg 120 includes a high-side fast-leg switch 121 configured to selectively conduct current between the fast-leg switch node 123 and the positive output node 131 of the PFC converter 101. The high-side fast-leg switch 121 includes a FET that can be controlled ON/OFF by a first high-frequency signal (S1) at its gate terminal. The fast leg 120 also includes a low-side fast-leg switch 122 configured to selectively conduct current between the fast-leg switch node 123 and the negative output node 132 of the PFC converter 101. The low-side fast-leg switch 122 includes a FET that can be controlled ON/OFF by a second high-frequency signal (S2) at its gate terminal.

The fast leg 120 can be configured to switch ON/OFF at the PWM frequency. In other words, switching signals S1 and S2 can switch at a PWM frequency in order to generate the DC output voltage V_{OUT} between the positive output node 131 and the negative output node 132. Switching the high-side fast-leg switch 121 and the low-side fast-leg switch 122 can operate the fast leg 120 to perform the power transfer (i.e., boost conversion) and can facilitate power factor correction.

The slow leg 110 is configured to switch ON/OFF at a frequency corresponding to the AC power source 102. For example, low-frequency switching signals SR1 and SR2 can switch at twice the AC line frequency to operate the slow-leg high-side switch 111 and the slow-leg low-side switch 112 for synchronous rectification. The synchronous rectification process includes providing a high efficiency conduction path for an input current (I_{IN}) to return to the AC power source 102. The synchronous rectification using switches can eliminate the need for a diode bridge. Accordingly, the PFC converter 101 may be referred to as a bridgeless PFC converter or a totem pole PFC converter. Either the slow-leg high-side switch 111 or the slow-leg low-side switch 112 is driven ON during a half-cycle of the line voltage (VAC), and the one of the slow-leg high-side switch 111 or the slow-leg low-side switch 112 that is driven ON may alternate based on a polarity of the line voltage (V_{AC}).

As shown in FIG. 1, the controller 150 may be configured to sense a voltage between the first AC input node 124 and the second AC input node 125 in order to determine a polarity of the line voltage V_{AC}, when a change in the polarity occurs, and/or a type of polarity change (e.g., positive-to-negative, negative-to-positive). For example, the controller may be configured to determine if the AC power source 102 is in a positive VAC half-cycle and a negative VAC half cycle. Based on this determination, the controller 150 may adjust the control of the switches 111, 112, 121, 122 according to the polarity of the line voltage V_{AC}. In practice, the controller 150 may be further configured to disable switching signals (i.e., drive signals) before and/or after a zero crossing of the line voltage V_{AC}. For example, the controller 150 may implement a dead band where both of the slow-leg high-side switch 111 and the slow-leg low-side switch 112 are off for a period of time around the zero crossing of the AC line voltage V_{AC}, in order to avoid causing a short circuit between the positive output node 131 and the negative output node 132, which could occur if both of the slow-leg high-side switch 111 and the slow-leg low-side switch 112 were in a conductive state simultaneously.

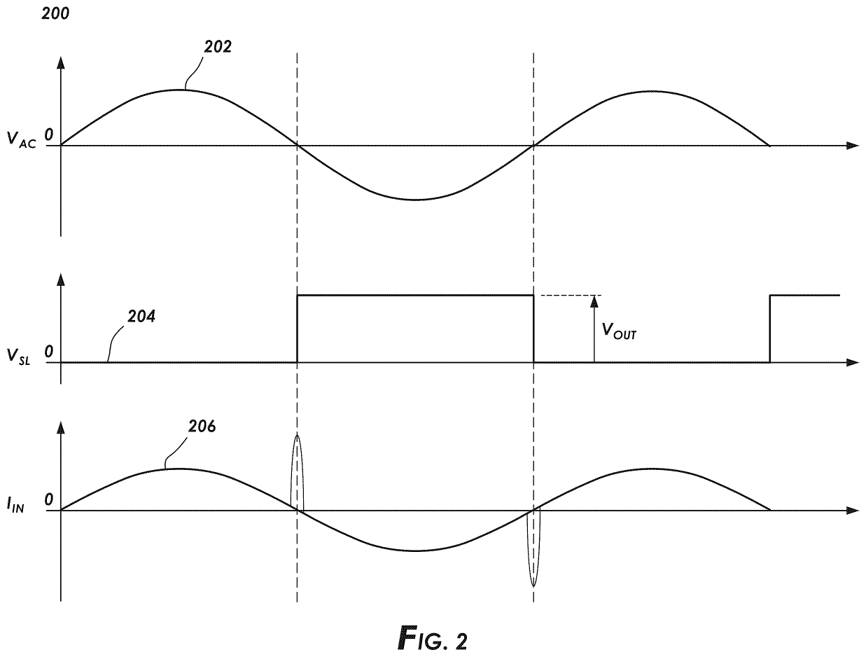

FIG. 2 shows a first graph 200 illustrating operation of the PFC converter 101 of FIG. 1. The first graph 200 includes several plots 202, 204, 206, illustrating various signals or conditions over a common time scale. The first graph 200 includes a first plot 202 showing the AC line voltage V_{AC} between the first AC input node 124 and the second AC input node 125. The first graph 200 also includes a second plot 204 showing a slow-leg voltage V_{SL} on the second AC input node 125. The first graph 200 also includes a third plot 206 showing input current I_{IN} supplied to the PFC converter 101. As shown on FIG. 2, at each zero crossing of the AC line voltage V_{AC}, the slow-leg voltage V_{SL} is rapidly changed between zero volts and the DC output voltage V_{OUT}. This rapid switching is a result of the slow-leg high-side switch 111 and the slow-leg low-side switch 112 switching states to perform the synchronous rectification. This rapid switching of the slow-leg voltage V_{SL} can cause transient currents that can result in surges in input current and/or input voltage, common mode noise, and/or EMI (Electromagnetic Interference). Plot 206 shows positive and negative spikes in the input current I_{IN} around the zero crossing of the AC line voltage V_{AC}, and which result from the rapid changing of the slow-leg voltage V_{SL}. Plot 206 may represent a simplified version of an actual spike in the input current I_{IN}, which may not be to scale. The actual magnitude and duration of the spike in the input current I_{IN} caused by the rapid changing of the slow-leg voltage V_{SL} may vary based on numerous real-world considerations, such as physical properties of devices that comprise the PFC system 100.

In conventional totem pole PFC designs, such as the PFC converter 101 of FIG. 1, FETs of the slow-leg high-side switch 111 and the slow-leg low-side switch 112 may be driven directly between a non-conductive state and a conductive state by application of digital control signals. As described, this switching operation can cause undesirable effects, such as common mode noise and/or EMI.

The present disclosure provides systems and methods for totem pole power factor correction (PFC) converters that include operating one or more FETs in a saturation mode to progressively change the slow-leg voltage V_{SL} on the second AC input node 125. Progressively changing the slow-leg voltage V_{SL} may include varying the slow-leg voltage V_{SL} between zero volts and the DC output voltage V_{OUT} over a period of time that is substantially longer than a near-instantaneous change that would otherwise result from directly switching FETs of the slow-leg high-side switch 111 and the slow-leg low-side switch 112 between a non-conductive state and a conductive state by application of digital control signals. By progressively changing the slow-leg voltage V_{SL}, the systems and methods of the present disclosure can reduce or eliminate the spikes in the input current I_{IN} around the zero crossing of the AC line voltage V_{AC}, which can otherwise cause undesirable effects. In the saturation mode, which may also be called an active mode, the FET may behave as a constant-current source rather than as a switch. A FET, in the saturation mode, can effectively be used as a voltage amplifier in order to progressively vary the slow-leg voltage V_{SL} over a period of time.

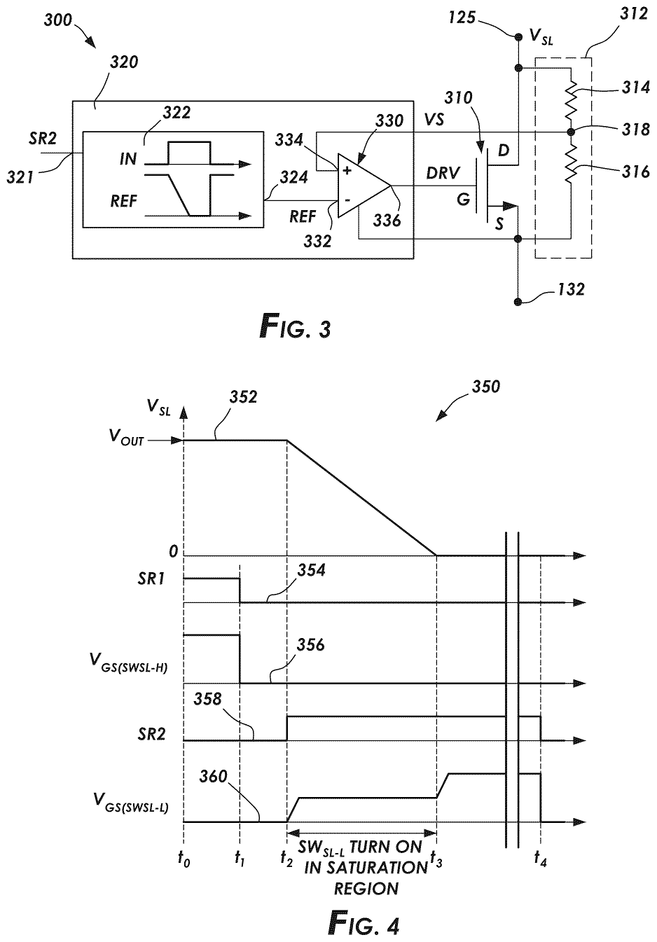

FIG. 3 shows a schematic block diagram of a first slow-leg switch 300 of the present disclosure. The first slow-leg switch 300 may be used as the slow-leg low-side switch 112 and/or as the slow-leg high-side switch 111 in the PFC converter 101. However, to simplify the disclosure, the first slow-leg switch 300 is shown and described as a low-side switch that is configured to selectively conduct current between the second AC input node 125 and the negative output node 132 of the PFC converter 101. The present description of the first slow-leg switch 300 includes several references to voltages on different terminals. The described voltages may each be relative to the negative output node 132, which may be connected to ground.

The first slow-leg switch 300 includes a first rectification FET 310 having drain, source and gate terminals, labeled D, S, and G, respectively. The drain terminal D of the first rectification FET 310 is connected to the second AC input node 125, and the source terminal S of the first rectification FET 310 is connected to the negative output node 132. The first rectification FET 310 is configured to conduct current between the second AC input node 125 and the negative output node 132, based on a voltage applied to the gate terminal G. The first slow-leg switch 300 is configured to operate the first rectification FET 310 in a saturation mode to progressively change a voltage on the second AC input node 125.

As shown on FIG. 3, the first slow-leg switch 300 includes a first voltage scaler 312 connected between the second AC input node 125 and the negative output node 132. The first voltage scaler 312 is configured to generate a sensed voltage signal V_{S} on a first sensor terminal 318, based on the slow-leg voltage V_{SL} on the second AC input node 125. The first voltage scaler 312 shown on FIG. 3 includes a resistive divider having a first resistor 314 in series with a second resistor 316 and defining the first sensor terminal 318 therebetween. However, other types of voltage scalers may be used, such as a capacitive divider. The sensed voltage signal V_{S} may be a fraction of the slow-leg voltage V_{SL}, and the fraction may be based on a ratio of the resistances of the first resistor 314 and the second resistor 316.

The first slow-leg switch 300 also includes a first driver circuit 320 configured to apply a voltage to the gate G of the first rectification FET 310 for controlling operation of the first rectification FET 310 to conduct current between the second AC input node 125 and the negative output node 132. The first driver circuit 320 defines an input terminal 321 coupled to the controller 150 for receiving the second synchronous rectification signal SR2. The first driver circuit 320 includes a reference signal generator 322 that defines a reference output terminal 324. The reference signal generator 322 is coupled to the input terminal 321 and is configured to progressively vary a reference signal REF on the reference output terminal 324 in response to a digital input signal. For example, the reference signal generator 322 may reduce a voltage of the reference output terminal 324 in a linear fashion in response to the second synchronous rectification signal SR2 being asserted, such as by transitioning from a low-level condition to a high-level condition. After the progressive varying is complete, such as when the reference signal REF has reached a final value, the reference signal generator 322 may maintain the reference signal REF on the reference output terminal 324. For example, as shown on FIG. 3, the reference signal generator 322 may maintain the reference signal REF at a zero-voltage state as long as the second synchronous rectification signal SR2 remains at the high-level condition. The reference signal generator 322 may reset the reference signal REF on the reference output terminal 324 in response to the second synchronous rectification signal SR2 being de-asserted, such as by transitioning from the high-level condition to the low-level condition.

The first slow-leg switch 300 also includes an amplifier 330 defining a first input terminal 332, a second input terminal 334, and an output terminal 336 that is connected to the gate G of the first rectification FET 310. The first input terminal 332 is configured as an inverting (−) input, and the second input terminal 334 is configured as a non-inverting input (+). However, the configurations of the first input terminal 332 and the second input terminal 334 may be different. The first input terminal 332 of the amplifier 330 is connected to the reference output terminal 324 of the reference signal generator 322, and the second input terminal 334 is connected to the first sensor terminal 318 of the first voltage scaler 312. The amplifier 330 may include, for example, an operational amplifier (op-amp) that is configured to generate a drive voltage DRV on the output terminal 336 based on a difference between the sensed voltage signal V_{S} and the reference signal REF. The amplifier 330, therefore, functions as a controller for regulating a voltage applied to the gate G of the first rectification FET 310 based on the difference between the sensed voltage signal V_{S} and the reference signal REF. The first slow-leg switch 300 may, therefore, operate the first rectification FET 310 in a saturation mode to progressively change the slow-leg voltage V_{SL} on the second AC input node 125 over a period of time that the reference signal generator 322 varies the reference signal REF on the reference output terminal 324.

The first slow-leg switch 300 may be further configured to drive the first rectification FET 310 to a low-impedance state, which may be called a conductive state, in response to the slow-leg voltage V_{SL} on the second AC input node 125 reaching a target voltage, as a result of the first rectification FET 310 operating in the saturation mode. For example, the reference signal generator 322 may drive the reference signal REF on the reference output terminal 324 to zero volts or a negative voltage after the progressive varying is complete, such as when the reference signal REF has reached a final value. When the slow-leg voltage V_{SL} on the second AC input node 125 reaches a target voltage of zero volts, due to the first rectification FET 310 operating in the saturation mode, the sensed voltage signal V_{S} also reaches zero. Then, the amplifier 330 may compare the sensed voltage signal V_{S} to the reference signal REF. When the sensed voltage signal V_{S} reaches zero, the amplifier 330 may apply a predetermined maximum voltage to the gate G of the first rectification FET 310, which is sufficient to drive the first rectification FET 310 to the low impedance state, and which is maintained until the second synchronous rectification signal SR2 is de-asserted. By operating the first rectification FET 310 in the low-impedance state, resistive power loss in the first rectification FET 310 may be substantially reduced.

FIG. 4 shows a second graph 350 illustrating operation of a slow-leg bridge in a totem pole PFC, with the first slow-leg switch 300 of FIG. 3. The second graph 350 includes several plots 352, 354, 356, 358, 360 illustrating various signals or conditions over a common time scale. The second graph 350 includes a first plot 352 showing the slow-leg voltage V_{SL} on the second AC input node 125. The second graph 350 also includes a second plot 354 showing the first synchronous rectification signal SR1 for controlling operation of the slow-leg high-side switch 111. The second graph 350 also includes a third plot 356 showing a gate-source voltage V_{GS(SWSL-H)} of the slow-leg high-side switch 111. The second graph 350 also includes a fourth plot 358 showing the second synchronous rectification signal SR2 for controlling operation of the first slow-leg switch 300 functioning as the slow-leg low-side switch 112. The second graph 350 also includes a fifth plot 360 showing a gate-source voltage V_{GS(SWSL-L)} of the first rectification FET 310 in the first slow-leg switch 300 functioning as the slow-leg low-side switch 112.

At an initial time t₀, the first synchronous rectification signal SR1 is in an asserted state, the slow-leg high-side switch 111 is conductive, and the first plot 352 shows the slow-leg voltage V_{SL} equal to the DC output voltage V_{OUT} on the a positive output node 131. The initial time t₀ corresponds to a negative half cycle, when the AC line voltage V_{AC} is negative. Subsequently, at time t₁, the first synchronous rectification signal SR1 is de-asserted, transitioning from a high-level condition to a low-level condition. This corresponds to a zero crossing of the AC line voltage V_{AC.} At time t₁, the gate-source voltage V_{GS(SWSL-H)} of the slow-leg high-side switch 111 drops to zero, indicating the slow-leg high-side switch 111 being switched to a non-conductive state. Subsequently, at time t₂, the second synchronous rectification signal SR1 is asserted and transitions from a low-level condition to a high-level condition. This corresponds to a positive half cycle, when the AC line voltage V_{AC} is positive.

Beginning at time t₂ and lasting for a period of time until subsequent time t₃, the first rectification FET 310 is operated in a saturation mode. The first rectification FET 310 is also called a slow-leg low switch (SW_{SL-L}). During this period between times t₂ to t₃, the gate-source voltage V_{GS(SWSL-L)} of the first rectification FET 310 is driven to and maintained at an intermediate value between its highest and lowest values. Thus, during this the period between times t₂ to t₃, the first rectification FET 310 is operated in a saturation mode to progressively change the slow-leg voltage V_{SL} on the second AC input node 125. The first plot 352 shows the slow-leg voltage V_{SL} progressive changing from the DC output voltage V_{OUT} at time t₂ and ramping to zero volts at time t₃.

At time t₃, when the slow-leg voltage V_{SL} reaches the target voltage of zero volts, the fifth plot 360 shows the gate-source voltage V_{GS(SWSL-L)} of the first rectification FET 310 at a higher value, corresponding to the first rectification FET 310 being driven to the low-impedance state. Subsequently after time t₃, the fourth plot 358 shows the second synchronous rectification signal SR2 being de-asserted at time t₄, transitioning from a high-level condition to a low-level condition. This corresponds to a zero crossing of the AC line voltage V_{AC.} The fifth plot 360 also shows de-asserting the synchronous rectification signal SR2 at time t₄ causing the gate-source voltage V_{GS(SWSL-L)} of the first rectification FET 310 to drop to zero, thereby causing the first rectification FET 310 to be in a non-conductive state.

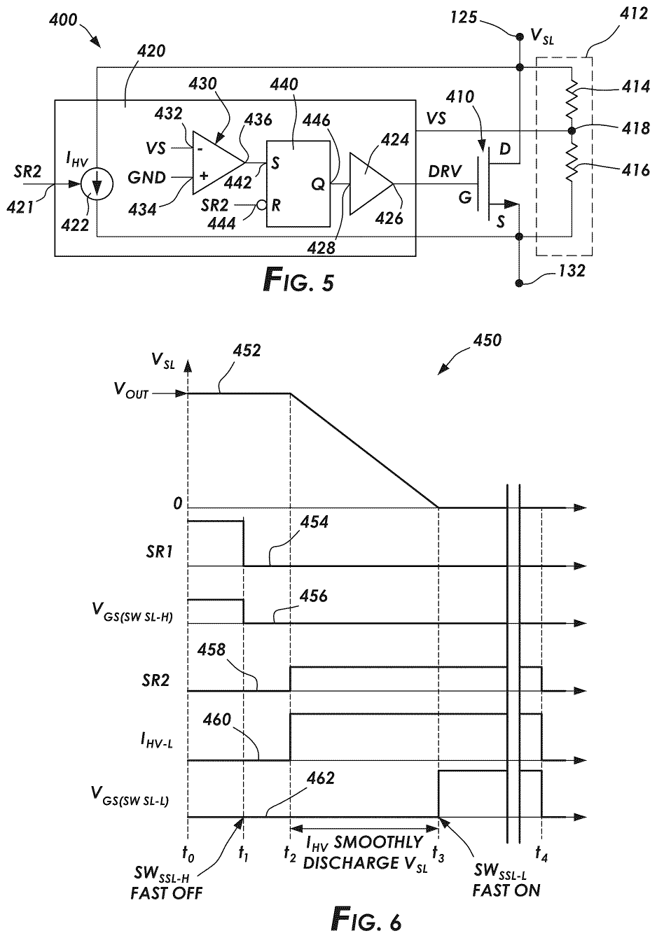

FIG. 5 shows a schematic block diagram of a second slow-leg switch 400 of the present disclosure. The second slow-leg switch 400 may be used as the slow-leg low-side switch 112 and/or as the slow-leg high-side switch 111 in the PFC converter 101. However, to simplify the disclosure, the second slow-leg switch 400 is shown and described as a low-side switch that is configured to selectively conduct current between the second AC input node 125 and the negative output node 132 of the PFC converter 101. The present description of the second slow-leg switch 400 includes several references to voltages on different terminals. The described voltages may each be relative to the negative output node 132, which may be connected to ground.

The second slow-leg switch 400 includes a second rectification FET 410 having drain, source and gate terminals, labeled D, S, and G, respectively. The drain terminal D of the second rectification FET 410 is connected to the second AC input node 125, and the source terminal S of the second rectification FET 410 is connected to the negative output node 132. The second rectification FET 410 is configured to selectively conduct current between the second AC input node 125 and the negative output node 132 in response to a control voltage applied to the gate terminal G.

The second slow-leg switch 400 also includes a second voltage scaler 412 connected between the second AC input node 125 and the negative output node 132. The second voltage scaler 412 is configured to generate a sensed voltage signal V_{S} on a second sensor terminal 418, based on the slow-leg voltage V_{SL} on the second AC input node 125. The second voltage scaler 412 shown on FIG. 5 includes a resistive divider having a third resistor 414 in series with a fourth resistor 416 and defining the second sensor terminal 418 therebetween. However, other types of voltage scalers may be used, such as a capacitive divider. The sensed voltage signal V_{S} may be a fraction of the slow-leg voltage V_{SL}, and the fraction may be based on a ratio of the resistances of the third resistor 414 and the fourth resistor 416.

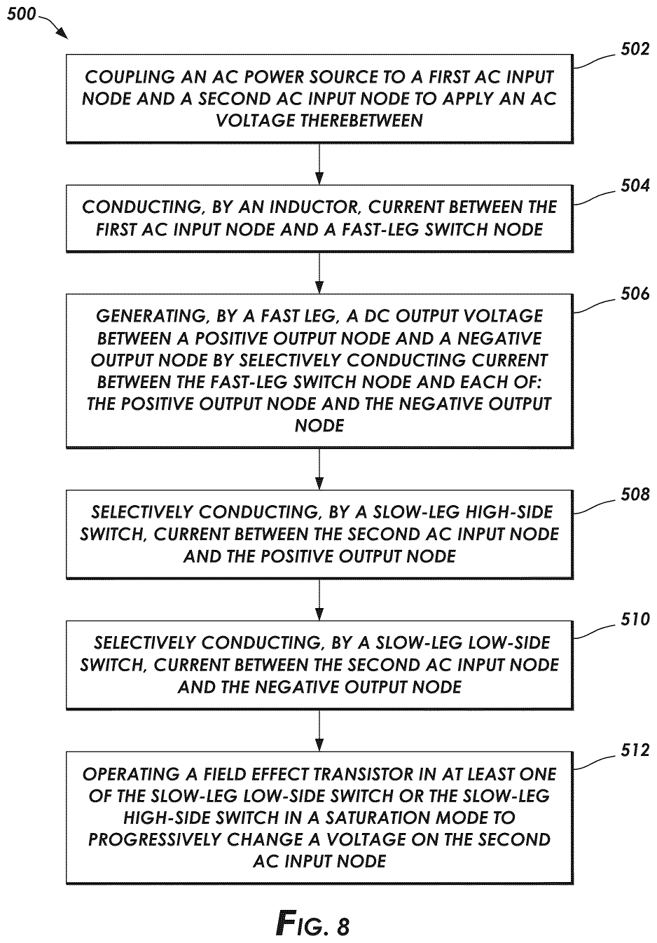

The second slow-leg switch 400 also includes a second driver circuit 420 configured to apply a voltage to the gate G of the second rectification FET 410 for controlling operation of the second rectification FET 410 to conduct current between the second AC input node 125 and the negative output node 132. The second driver circuit 420 defines an input terminal 421 coupled to the controller 150 for receiving the second synchronous rectification signal SR2. The second driver circuit 420 includes a current source 422 coupled to the input terminal 421 for receiving the second synchronous rectification signal SR2 as a digital input signal. The current source 422 is configured to conduct, in response to the second synchronous rectification signal SR2, a constant current I_{HV} between the second AC input node 125 and the negative output node 132. As described below with reference to FIG. 7, the current source 422 includes a second FET 472 that is operated in a saturation mode to conduct the constant current I_{HV} between the second AC input node 125 and the negative output node 132.

The second driver circuit 420 of the second slow-leg switch 400 includes a gate driver 424 that defines an output terminal 426 and an input terminal 428. The output terminal 426 of the gate driver 424 is connected to the gate G of the second rectification FET 410. The gate driver 424 may function as a buffer or an amplifier to apply a voltage to the gate G of the second rectification FET 410 and which is sufficient to drive the second rectification FET 410 to a low impedance state in response to the input terminal 428 having a high-level or asserted condition, where the signal on the input terminal 428 has a different voltage level and/or insufficient current supply capacity to drive the second rectification FET 410 to the low impedance state.

The second driver circuit 420 of the second slow-leg switch 400 also includes a comparator 430. As described below, the comparator 430 may determine the sensed voltage signal V_{S} on the second sensor terminal 418 being less than a target voltage, which happens as a result of the second FET 472 of the current source 422 being operated in a saturation mode, and then drive the second rectification FET 410 to a low impedance state. The comparator 430 defines a first input terminal 432, a second input terminal 434, and an output terminal 436. The first input terminal 432 is configured as an inverting (−) input, and the second input terminal 434 is configured as a non-inverting input (+). However, the configurations of the first input terminal 432 and the second input terminal 434 may be different. The first input terminal 432 of the comparator 430 is connected to the second sensor terminal 418 of the second voltage scaler 412, and the second input terminal 434 is connected to a reference node defining a target voltage. The second driver circuit 420 shown on FIG. 5 includes the reference node as a ground GND to define the target voltage of zero volts. However, another voltage source may be used to define a non-zero target voltage. The comparator 430 may be configured to energize the output terminal 436 in response to the sensed voltage signal V_{S} on the second sensor terminal 418 being less than the target voltage. For example, the comparator 430 may include an operational amplifier (op-amp) that functions to drive the output terminal 436 to a high-level condition, also called an energized state or an asserted state, in response to the sensed voltage signal V_{S} on the first input terminal 432 being less than or equal to the ground GND level voltage on the second input terminal 434.

The second driver circuit 420 of the second slow-leg switch 400 also includes a set-reset (SR) latch 440 defining a setting input 442, a resetting input 444, and a latched output 446. The setting input 442 is coupled to the output terminal 436 of the comparator 430. The resetting input 444 is active low and is coupled to the input terminal 421 for receiving the second synchronous rectification signal SR2. The latched output 446 is coupled to the second rectification FET 410 for maintaining the second rectification FET 410 in the low impedance state, beginning when the output terminal 436 of the comparator 430 is energized, and lasting until the second synchronous rectification signal SR2 is de-asserted.

In some embodiments, the latched output 446 is coupled to the second rectification FET 410 indirectly, via the gate driver 424. For example, as shown on FIG. 5, the latched output 446 of the SR latch 440 is coupled directly to the input terminal 428 of the gate driver 424. Alternatively, and if the SR latch 440 has sufficient capacity, the latched output 446 of the SR latch 440 may be coupled directly to the gate G of the second rectification FET 410.

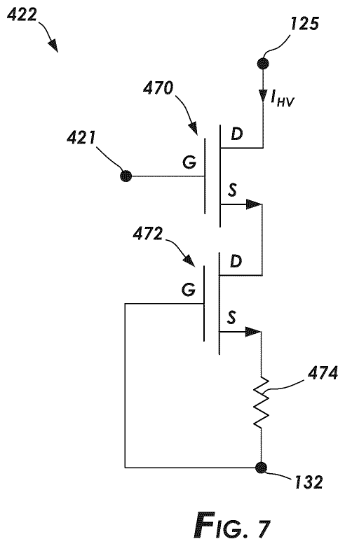

FIG. 6 shows a third graph 450 illustrating operation of a slow-leg bridge in a totem pole PFC, with the second slow-leg switch 400 of FIG. 5. The third graph 450 includes several plots 452, 454, 456, 458, 460 illustrating various signals or conditions over a common time scale. The third graph 450 includes a first plot 452 showing the slow-leg voltage V_{SL} on the second AC input node 125. The third graph 450 also includes a second plot 454 showing the first synchronous rectification signal SR1 for controlling operation of the slow-leg high-side switch 111. The third graph 450 also includes a third plot 456 showing a gate-source voltage V_{GS(SWSL-H)} of the slow-leg high-side switch 111. The third graph 450 also includes a fourth plot 458 showing the second synchronous rectification signal SR2 for controlling operation of the second slow-leg switch 400 functioning as the slow-leg low-side switch 112. The third graph 450 also includes a fifth plot 460 showing a gate-source voltage V_{GS(SWSL-L)} of the second rectification FET 410 in the second slow-leg switch 400 functioning as the slow-leg low-side switch 112.

At an initial time t₀, the first synchronous rectification signal SR1 is in an asserted state, the slow-leg high-side switch 111 is conductive, and the first plot 452 shows the slow-leg voltage V_{SL} equal to the DC output voltage V_{OUT} on the a positive output node 131. The initial time t₀ corresponds to a negative half cycle, when the AC line voltage V_{AC} is negative. Subsequently, at time t₁, the first synchronous rectification signal SR1 is de-asserted, transitioning from a high-level condition to a low-level condition. This corresponds to a zero crossing of the AC line voltage V_{AC.} At time t₁, the gate-source voltage V_{GS(SWSL-H)} of the slow-leg high-side switch 111 drops to zero, indicating the slow-leg high-side switch 111 being switched to a non-conductive state. The slow-leg high-side switch 111 is also called a slow-leg high switch (SW_{SL-H}). Subsequently, at time t₂, the second synchronous rectification signal SR1 is asserted and transitions from a low-level condition to a high-level condition. This corresponds to a positive half cycle, when the AC line voltage V_{AC} is positive.

Beginning at time t₂ and lasting for a period of time until subsequent time t₃, the current source 422 is activated, causing the second FET 472 to be operated in a saturation mode to conduct a constant current I_{HV} between the second AC input node 125 and the negative output node 132 The first plot 452 shows the slow-leg voltage V_{SL} progressive changing from the DC output voltage V_{OUT} at time t₂ and ramping to zero volts at time t₃ as a result of the current conducted by the current source 422.

At time t₃, when the slow-leg voltage V_{SL} reaches the target voltage of zero volts, the fifth plot 460 shows the gate-source voltage V_{GS(SWSL-L)} of the second rectification FET 410 being energized, corresponding to the second rectification FET 410 being driven to the low-impedance state. The second rectification FET 410 is also called a slow-leg low switch (SW_{SL-L}). Subsequently after time t₃, the fourth plot 458 shows the second synchronous rectification signal SR2 being de-asserted at time t₄, transitioning from a high-level condition to a low-level condition. This corresponds to a zero crossing of the AC line voltage V_{AC.} The fifth plot 460 also shows de-asserting the synchronous rectification signal SR2 at time t₄ causing the SR latch 440 to de-energize the latched output 446, and thereby causing the gate-source voltage V_{GS(SWSL-L)} of the second rectification FET 410 to drop to zero, thereby causing the second rectification FET 410 to be in a non-conductive state.

FIG. 7 shows a schematic diagram of a current source 422 of the second slow-leg switch 400 of FIG. 5. The schematic diagram shown on FIG. 7 is a simplified example circuit that may be used to selectively conduct the constant current I_{HV} between the second AC input node 125 and the negative output node 132 of the PFC converter 101. However, other circuit designs may be used to form the current source 422.

The current source 422 includes a first FET 470 that functions as a switch to selectively enable the current source 422 to conduct the constant current I_{HV} between the second AC input node 125 and the negative output node 132 of the PFC converter 101. The first FET 470 defines drain, source and gate terminals, labeled D, S, and G, respectively. The gate terminal G of the first FET 470 is connected to the input terminal 421 for receiving the second synchronous rectification signal SR2. The drain terminal D of the first FET 470 is connected to the second AC input node 125. Thus, the first FET 470 selectively conducts the constant current I_{HV} between the second AC input node 125 and its source terminal based on a logic level condition of the second synchronous rectification signal SR2. When the second synchronous rectification signal SR2 is at the high-level condition, the first FET 470 is in a conductive state, enabling the current source 422 to conduct the constant current I_{HV} between the second AC input node 125 and the negative output node 132 of the PFC converter 101. When the second synchronous rectification signal SR2 is at the low-level condition, the first FET 470 is in a non-conductive state, blocking the constant current source 422 from conducting the constant current I_{HV} between the second AC input node 125 and the negative output node 132 of the PFC converter 101.

The current source 422 also includes a second FET 472 that is operated in a saturation mode to regulate the constant current I_{HV}. The second FET 472 defines drain, source and gate terminals, labeled D, S, and G, respectively. The gate terminal G of the second FET 472 is connected to the negative output node 132. The drain terminal D of the second FET 472 is connected to the source terminal of the first FET 470. A resistor 474 is connected between the source terminal S of the second FET 472. The magnitude of the constant current I_{HV} may depend on a resistance value of the resistor 474, and may remain relatively constant as long as there is a sufficient voltage between the second AC input node 125 and the negative output node 132.

A method 500 for operating a power factor correction (PFC) converter is shown in the flow chart of FIG. 8. Various functions of the method 500 can be performed by the controller 150, in accordance with some embodiments of the present disclosure. As can be appreciated in light of the disclosure, the order of operation within the method is not limited to the sequential execution as illustrated in FIG. 8, but may be performed in one or more varying orders as applicable and in accordance with the present disclosure.

For simplicity of explanation, the method 700 is depicted in FIG. 8, and described below as a series of operations. However, the operations can occur in various orders and/or concurrently, and/or with other operations not presented and described herein. Further, for ease of explanation, the method 500 is depicted in FIG. 8, and described in relation to the PFC converter 101 illustrated in FIG. 1, with the first slow-leg switch 300 of FIG. 3 used as the slow-leg low-side switch 112. However, the operations of the method 500 can apply to other totem pole PFC converter designs, such as the PFC converter 101 illustrated in FIG. 1, with the first slow-leg switch 300 of FIG. 3 as the slow-leg high-side switch 111, or with the second slow-leg switch 400 of FIG. 5 used as either or both of the slow-leg high-side switch 111 and/or the slow-leg low-side switch 112.

At block 502, an AC power source is coupled to a first AC input node and a second AC input node to apply an AC voltage therebetween. For example, and with reference to FIG. 1, block 502 may include the AC power source 102 applying the AC line voltage V_{AC} between the first AC input node 124 and the second AC input node 125.

At block 504, current is conducted by an inductor between the first AC input node and a fast-leg switch node. For example, and with reference to FIG. 1, block 504 may include the inductor 104 conducting current between the first AC input node 124 and the fast-leg switch node 123 of the PFC converter 101.

At block 506, a DC output voltage is generated, by a fast leg, between a positive output node and a negative output node by selectively conducting current between the fast-leg switch node and each of: the positive output node and the negative output node. For example, and with reference to FIG. 1, block 506 may include the controller 150 commanding the high-side fast-leg switch 121 of the fast leg 120 to selectively conduct current between the fast-leg switch node 123 and the positive output node 131 of the PFC converter 101. Block 506 may also include the controller 150 commanding the low-side fast-leg switch 122 of the fast leg 120 to selectively conduct current between the fast-leg switch node 123 and the negative output node 132 of the PFC converter 101.

At block 508, a slow-leg high-side switch selectively conducts current between the second AC input node and the positive output node. For example, and with reference to FIG. 1, block 508 may include the controller 150 commanding the slow-leg high-side switch 111 of the slow leg 110 to selectively conduct current between the second AC input node 125 and the positive output node 131 of the PFC converter 101.

At block 510, a slow-leg low-side switch selectively conducts current between the second AC input node and the negative output node. For example, and with reference to FIG. 1, block 510 may include the controller 150 commanding the slow-leg low-side switch 112 to selectively conduct current between the second AC input node 125 and the negative output node 132 of the PFC converter 101.

Blocks 508 and 510 may be toggled according to a polarity of an AC line voltage V_{AC}, to perform a synchronous rectification function. In other words, the slow-leg high-side switch 111 and the slow-leg low-side switch 112 may each be driven to a conductive state at different times for rectifying AC power from the AC power source 102.

At block 512, a field effect transistor in at least one of the slow-leg low-side switch or the slow-leg high-side switch is operated in a saturation mode to progressively change a voltage on the second AC input node. For example, and with reference to FIG. 3, block 512 may include the first slow-leg switch 300 operating the first rectification FET 310 in a saturation mode to progressively reduce the slow-leg voltage V_{SL} on the second AC input node 125 over the period between times t₂ to t₃, shown on the graph of FIG. 4. In another example, and with reference to FIGS. 5 and 7, block 512 may include the second FET 472 of the current source 422 being operated in a saturation mode to conduct a constant current between the second AC input node 125 and the negative output node 132, and to thereby progressively reduce the slow-leg voltage V_{SL} on the second AC input node 125 over the period between times t₂ to t₃, shown on the graph of FIG. 6.

In some embodiments, block 512 includes operating field effect transistors in each of the slow-leg low-side switch and the slow-leg high-side switch in the saturation mode to progressively change the voltage on the second AC input node. For example, a totem pole PFC converter can be constructed with both the slow-leg high-side switch 111 and the slow-leg low-side switch 112 including circuits similar or identical to the first slow-leg switch 300 and/or the second slow-leg switch 400.

In some embodiments, the method 500 may further include: determining, by an amplifier, the voltage on the second AC input node reaching a target voltage as a result of the field effect transistor operating in the saturation mode; and driving the field effect transistor to a low impedance state in response to determining the voltage on the second AC input node reaching the target voltage. For example, and with reference to the first slow-leg switch 300 of FIG. 3, when the slow-leg voltage V_{SL} on the second AC input node 125 reaches a target voltage of zero volts, due to the first rectification FET 310 operating in the saturation mode, the sensed voltage signal V_{S} also reaches zero. Then, the amplifier 330 may compare the sensed voltage signal V_{S} to the reference signal REF. When the sensed voltage signal V_{S} reaches zero, the amplifier 330 may apply a predetermined maximum voltage to the gate G of the first rectification FET 310, which is sufficient to drive the first rectification FET 310 to the low impedance state.

In some embodiments, the method 500 may further include: generating, by a voltage scaler coupled to the second AC input node, a sensed voltage signal based on the voltage on the second AC input node, and determining the voltage on the second AC input node reaching the target voltage further includes comparing, by the amplifier, the sensed voltage signal to a reference voltage. For example, and with reference to the first slow-leg switch 300 of FIG. 3, the first voltage scaler 312 may generate a sensed voltage signal V_{S} on a first sensor terminal 318, based on the slow-leg voltage V_{SL} on the second AC input node 125, and the amplifier 330 may compare the sensed voltage signal V_{S} to the to the reference signal REF in order to determine the slow-leg voltage V_{SL} on the second AC input node 125 reaching the target voltage.

In some embodiments, the method 500 may further include: generating, by a voltage scaler coupled to the second AC input node, a sensed voltage signal based on the voltage on the second AC input node; progressively varying, by reference signal generator a reference signal, in response to a digital input signal; and generating, by an amplifier, a drive voltage on an output terminal based on a difference between the sensed voltage signal and the reference signal, wherein the output terminal is connected to a gate of the field effect transistor, and wherein generating the drive voltage on the output terminal causes the field effect transistor to operate in the saturation mode to progressively change the voltage on the second AC input node. For example, and with reference to the first slow-leg switch 300 of FIG. 3, the first voltage scaler 312 may generate a sensed voltage signal V_{S} on a first sensor terminal 318, based on the slow-leg voltage V_{SL} on the second AC input node 125. Additionally, the reference signal generator 322 may reduce a voltage the reference output terminal 324 in a linear fashion in response the second synchronous rectification signal SR2 being asserted, such as by transitioning from a low-level condition to a high-level condition. Additionally, the amplifier 330 may generate a drive voltage DRV on the output terminal 336, which is connected to the gate G of the first rectification FET 310, based on a difference between the sensed voltage signal V_{S} and the reference signal REF and thus cause the first rectification FET 310 to operate in a saturation mode to progressively change the slow-leg voltage V_{SL} on the second AC input node 125 over a period of time that the reference signal generator 322 varies the reference signal REF on the reference output terminal 324.

In some embodiments, the method 500 may further include: conducting, in response to a digital input signal, and by a current source, a constant current between the second AC input node and a corresponding one of the positive output node or the negative output node, and the current source may include the field effect transistor operated in the saturation mode to progressively change the voltage on the second AC input node. For example, and with reference to the second slow-leg switch 400 of FIG. 5 and the current source 422 of FIG. 7, the second FET 472 of the current source 422 may be operated in a saturation mode to conduct a constant current between the second AC input node 125 and the negative output node 132, and to thereby progressively reduce the slow-leg voltage V_{SL} on the second AC input node 125 over the period between times t₂ to t₃, shown on the graph of FIG. 6.

In some embodiments, the method 500 may further include: selectively conducting, by a second field effect transistor, current between the second AC input node and a corresponding one of the positive output node of the negative output node. For example, and with reference to the second slow-leg switch 400 of FIG. 5, the second rectification FET 410 may selectively conduct current between the second AC input node 125 and the negative output node 132 in a parallel path to the current source 422.

In some embodiments, the method 500 may further include: driving, by a comparator, the second field effect transistor to a low impedance state in response to the voltage on the second AC input node reaching a target voltage as a result of the field effect transistor operating in the saturation mode. For example, and with reference to the second slow-leg switch 400 of FIG. 5, the comparator 430 may determine the sensed voltage signal V_{S} on the second sensor terminal 418 being less than a target voltage, which happens as a result of the second FET 472 of the current source 422 being operated in a saturation mode. Because the sensed voltage signal V_{S} represents the slow-leg voltage V_{SL} on the second AC input node 125, determining the sensed voltage signal V_{S} on the second sensor terminal 418 being less than a target voltage may also correspond to determining the slow-leg voltage V_{SL} on the second AC input node 125 reaching a corresponding target voltage value. The comparator 430 may then drive the second rectification FET 410 to the low impedance state in response to determining the slow-leg voltage V_{SL} on the second AC input node 125 reaching the corresponding target voltage value.

In some embodiments, the method 500 may further include: generating, by a voltage scaler coupled to the second AC input node, a sensed voltage signal based on the voltage on the second AC input node; and monitoring, by the comparator, the sensed voltage signal and the target voltage. For example, and with reference to the second slow-leg switch 400 of FIG. 5, the second voltage scaler 412 may generate the sensed voltage signal V_{S} on a second sensor terminal 418, based on the slow-leg voltage V_{SL} on the second AC input node 125. The comparator 430 may monitor each of the sensed voltage signal V_{S} on the first input terminal 432 and a target voltage on the second input terminal 434 in order to determine the sensed voltage signal V_{S} on the second sensor terminal 418 being less than the target voltage.

In some embodiments, the method 500 may further include: energizing, by the comparator, an output terminal in response to the sensed voltage signal being less than the target voltage, wherein the output terminal is coupled to a setting input of a set-reset (SR) latch; and maintaining, by the SR latch, the second field effect transistor in the low impedance state in response to the setting input being energized. For example, and with reference to the second slow-leg switch 400 of FIG. 5, the setting input 442 of the SR latch 440 is coupled to the output terminal 436 of the comparator 430. The latched output 446 of the SR latch 440 is coupled to the second rectification FET 410 for maintaining the second rectification FET 410 in the low impedance state, beginning when the output terminal 436 of the comparator 430 is energized, and lasting until the second synchronous rectification signal SR2 is de-asserted.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A power factor correction (PFC) converter, comprising:
a totem pole network having a first AC input node and a second AC input node, together configured to be coupled to an AC power source;
an inductor connected between the first AC input node and a fast-leg switch node;
a fast leg configured to generate a DC output voltage between a positive output node and a negative output node by selectively conducting current between the fast-leg switch node and each of: the positive output node and the negative output node; and
a slow leg including: a slow-leg high-side switch, and a slow-leg low-side switch, wherein the slow-leg high-side switch is configured to selectively conduct current between the second AC input node and the positive output node, and wherein the slow-leg low-side switch is configured to selectively conduct current between the second AC input node and the negative output node,
wherein at least one of the slow-leg low-side switch or the slow-leg high-side switch includes a field effect transistor that is configured to be operated in a saturation mode to progressively change a voltage on the second AC input node.

2. The PFC converter of claim 1, wherein the slow-leg low-side switch includes the field effect transistor that is configured to be operated in the saturation mode to progressively change the voltage on the second AC input node, and
wherein the slow-leg high-side switch includes another field effect transistor that is configured to be operated in the saturation mode to progressively change the voltage on the second AC input node.

3. The PFC converter of claim 1, wherein the at least one of the slow-leg low-side switch or the slow-leg high-side switch further includes an amplifier, wherein the amplifier is configured to drive the field effect transistor to a low impedance state in response to the voltage on the second AC input node reaching a target voltage as a result of the field effect transistor operating in the saturation mode.

4. The PFC converter of claim 3, wherein the at least one of the slow-leg low-side switch or the slow-leg high-side switch further includes a voltage scaler coupled to the second AC input node and configured to generate a sensed voltage signal based on the voltage on the second AC input node, and
wherein the amplifier is configured to compare the sensed voltage signal against a reference voltage to determine the voltage on the second AC input node reaching the target voltage.

5. The PFC converter of claim 3, wherein the at least one of the slow-leg low-side switch or the slow-leg high-side switch further includes:
a voltage scaler coupled to the second AC input node and configured to generate a sensed voltage signal based on the voltage on the second AC input node; and
a reference signal generator configured to progressively vary a reference signal in response to a digital input signal,
wherein the amplifier defines an output terminal connected to a gate of the field effect transistor, a first input terminal connected to the reference signal generator for monitoring the reference signal, and a second input terminal connected to the voltage scaler for monitoring the sensed voltage signal, and
wherein the amplifier is further configured to generate a drive voltage on the output terminal based on a difference between the sensed voltage signal and the reference signal, thereby causing the field effect transistor to operate in the saturation mode to progressively change the voltage on the second AC input node.

6. The PFC converter of claim 1, wherein the at least one of the slow-leg low-side switch or the slow-leg high-side switch further includes a current source configured to conduct, in response to a digital input signal, a constant current between the second AC input node and a corresponding one of the positive output node or the negative output node, and
wherein the current source includes the field effect transistor configured to be operated in the saturation mode.

7. The PFC converter of claim 1, wherein the at least one of the slow-leg low-side switch or the slow-leg high-side switch further includes a second field effect transistor configured to selectively conduct current between the second AC input node and a corresponding one of the positive output node of the negative output node.

8. The PFC converter of claim 7, wherein the at least one of the slow-leg low-side switch or the slow-leg high-side switch further includes a comparator configured to drive the second field effect transistor to a low impedance state in response to the voltage on the second AC input node reaching a target voltage as a result of the field effect transistor operating in the saturation mode.

9. The PFC converter of claim 8, wherein the at least one of the slow-leg low-side switch or the slow-leg high-side switch further includes:
a voltage scaler coupled to the second AC input node and configured to generate a sensed voltage signal based on the voltage on the second AC input node; and
wherein the comparator defines a first input terminal connected to the voltage scaler for monitoring the sensed voltage signal, and a second input terminal connected to a reference node defining the target voltage.

10. The PFC converter of claim 9, wherein the comparator defines an output terminal, and wherein the comparator is configured to energize the output terminal in response to the sensed voltage signal at the first input terminal being less than the target voltage at the second input terminal, and
wherein the at least one of the slow-leg low-side switch or the slow-leg high-side switch further includes: a set-reset (SR) latch defining a setting input coupled to the output terminal of the comparator, and a latched output coupled to the second field effect transistor for maintaining the second field effect transistor in the low impedance state.

11. A method for operating a power factor correction (PFC) converter, the method comprising:
coupling an AC power source to a first AC input node and a second AC input node to apply an AC voltage therebetween;
conducting, by an inductor, current between the first AC input node and a fast-leg switch node;
generating, by a fast leg, a DC output voltage between a positive output node and a negative output node by selectively conducting current between the fast-leg switch node and each of: the positive output node and the negative output node;
selectively conducting, by a slow-leg high-side switch, current between the second AC input node and the positive output node;
selectively conducting, by a slow-leg low-side switch, current between the second AC input node and the negative output node; and
operating a field effect transistor in at least one of the slow-leg low-side switch or the slow-leg high-side switch in a saturation mode to progressively change a voltage on the second AC input node.

12. The method of claim 11, wherein operating the field effect transistor in at least one of the slow-leg low-side switch or the slow-leg high-side switch in a saturation mode to progressively change the voltage on the second AC input node includes:
operating field effect transistors in each of the slow-leg low-side switch and the slow-leg high-side switch in the saturation mode to progressively change the voltage on the second AC input node.

13. The method of claim 11, further comprising:
determining, by an amplifier, the voltage on the second AC input node reaching a target voltage as a result of the field effect transistor operating in the saturation mode; and
driving the field effect transistor to a low impedance state in response to determining the voltage on the second AC input node reaching the target voltage.

14. The method of claim 13, further comprising:
generating, by a voltage scaler coupled to the second AC input node, a sensed voltage signal based on the voltage on the second AC input node, and
wherein determining the voltage on the second AC input node reaching the target voltage further includes comparing, by the amplifier, the sensed voltage signal to a reference voltage.

15. The method of claim 13, further comprising:
generating, by a voltage scaler coupled to the second AC input node, a sensed voltage signal based on the voltage on the second AC input node;
progressively varying, by reference signal generator a reference signal, in response to a digital input signal; and
generating, by an amplifier, a drive voltage on an output terminal based on a difference between the sensed voltage signal and the reference signal, wherein the output terminal is connected to a gate of the field effect transistor, and wherein generating the drive voltage on the output terminal causes the field effect transistor to operate in the saturation mode to progressively change the voltage on the second AC input node.

16. The method of claim 11, further comprising: conducting, in response to a digital input signal, and by a current source, a constant current between the second AC input node and a corresponding one of the positive output node or the negative output node, and
wherein the current source includes the field effect transistor operated in the saturation mode to progressively change the voltage on the second AC input node.

17. The method of claim 11, further comprising: selectively conducting, by a second field effect transistor, current between the second AC input node and a corresponding one of the positive output node of the negative output node.

18. The method of claim 17, further comprising: driving, by a comparator, the second field effect transistor to a low impedance state in response to the voltage on the second AC input node reaching a target voltage as a result of the field effect transistor operating in the saturation mode.

19. The method of claim 18, further comprising:
generating, by a voltage scaler coupled to the second AC input node, a sensed voltage signal based on the voltage on the second AC input node; and
monitoring, by the comparator, the sensed voltage signal and the target voltage.

20. The method of claim 19, further comprising:
energizing, by the comparator, an output terminal in response to the sensed voltage signal being less than the target voltage, wherein the output terminal is coupled to a setting input of a set-reset (SR) latch; and
maintaining, by the SR latch, the second field effect transistor in the low impedance state in response to the setting input being energized.
